(19) United States
(12) Patent Application Publication
(10) Pub. No.: US 2012/0081913 A1
(43) Pub. Date: Apr. 5, 2012

(54) BARREL MOUNTED CLAMP HAVING INTEGRATED ACCESSORY HOLDER

(76) Inventor: Arthur Scott Dew, Arlington, TX (US)

(21) Appl. No.: 13/194,979

(22) Filed: Jul. 31, 2011

Related U.S. Application Data
(60) Provisional application No. 61/369,730, filed on Aug. 1, 2010.

(51) Int. Cl. F21V 21/088

(52) U.S. Cl. 362/396

(57) ABSTRACT

In accordance with the present invention there is provided an accessory holder incorporated into a clamp section that, when cooperatively engaging a barrel and magazine tube of a firearm with a supporting clamping section, provides an accessory mount for that firearm.

### RELATED APPLICATIONS

The present application is a continuation of U.S. provisional patent application, Ser. No. 61/369,730, Filed Aug. 1, 2010, for BARREL MOUNTED CLAMP HAVING INTEGRATED ACCESSORY HOLDER, by Arthur Dew, included by reference herein and for which benefit of priority date is hereby claimed.

### FIELD OF THE INVENTION

The present invention relates to a barrel mounted accessory clamp and, more particularly, to barrel mounted accessory clamps that have an integral accessory mount.

### BACKGROUND OF THE INVENTION

Over the years, people using firearms have also used flashlights during conditions of darkness to provide illumination of a potential target or object in order to identify it. The issue of holding a light and a weapon at the same time is problematic when the use of a hand is required for other duties such as to open a door or reach for an object. It additionally becomes difficult to direct the light in a constant position parallel with the direction of the barrel. Further, it reduces the hold required on the firearm to adequately and safely manipulate the weapon when both hands are required.

Devices were created to mount a flashlight on a firearm and return more control to the person employing the weapon. The flashlight could then be used while leaving a hand free to move objects or perform other tasks. The flashlight would also be pointed steadily in the direction the barrel was pointing.

Two examples, D. D. Bailiff U.S. Pat. No. 2,447,892 and P. P. Basterreix U.S. Pat. No. 1,702,101 both disclose devices to clamp a flashlight to a barrel of a weapon. However these devices are subject to rotational displacement during recoil when the weapon is fired. Additionally there remains the possibility of the weapon sights being blocked by the flashlight or by parts of the device itself.

Another example is J. L. Verdin, U.S. Pat. No. 4,697,226 which discloses a device that is placed over a barrel and magazine tube of a firearm and is secured by a retaining nut on the end of the magazine tube. The device then allows a flashlight to be attached above the barrel. One problem with this design is the flashlight blocks the sights of the firearm when the light isn't needed. Another problem is removal of the light may not make it immediately available when it is needed. Additionally the firearm must be partially dismantled in order to remove or attach the device. This can lead to lost components or incorrect re-assembly.

Also known in the art are clamps, with attached rails, that engage the barrel and magazine tube. A tertiary device, such as a scope ring or other device that receives a flashlight, may then be attached to the rail on the clamps. However, the lateral build up of components add weight and complexity to the mount. Storage would also be problematic in narrow confines such as a gun case or a gun rack in a police cruiser. Another problem when using multiple components is the loss or misplacement of the tertiary device when it is removed such as when the firearm is placed in storage. Dedicated tactical flashlights with built in mounting rail receivers can also be used on this device. The problem is the expense of these lights makes it difficult for some to purchase.

Another example is C. L. Hansen and T. J. Soyka, U.S. Pat. No. 5,913,669 which displays a pair of cooperating clamps that engage a barrel and magazine tube of a shotgun providing a mount that allows the use of a light with an integral receiving rail below the magazine tube. The configuration of the light makes it proprietary to the mount and thus not easily replaced should failure or malfunction occur. A further problem is that multiple components add weight and changes the balance of the weapon.

Accordingly there remains a need to provide a device that removably couples securely to the firearm. There is a need to eliminate rotational displacement of the device. The need also exists for a device constructed of reduced components. Additionally a need exists to provide a mount for non proprietary illumination devices

### SUMMARY OF THE INVENTION

In accordance with the present invention there is provided an accessory holder incorporated into a clamping body section that, when cooperatively engaging a barrel and magazine tube of a firearm with a supporting clamping section, provides an accessory mount for that firearm.

The mount is comprised of a pair of opposing cooperative clamping sections; The first and second clamping sections are arranged in opposing fashion around the barrel and magazine tube. They are fastened in union with one or more fasteners to provide a secure coupling to the firearm.

The first clamping section includes in its structure a compressible opening such as a sleeve, ring or clamping flange with a clamping body, on the outside of the clamp where a flashlight can be inserted. This opening, when engaged by one or more fasteners, secures the flashlight by compressing a portion of that opening against the body of the flashlight.

The second clamping section has the ability to optionally provide for additional attachments on the outside of the clamp.

The inside of each clamp section includes two arched mounting surfaces adapted to couple a barrel and magazine of a firearm. One mounting surface approximates the profile of the barrel while the second approximates the profile of the magazine tube.

The device may be formed from a metal such as aluminum, steel or other metal or metal alloy, various synthetic or composite materials such as a polymers or any combination thereof.

Therefore the device eliminates the need for tertiary attachments to secure a flashlight. Rotational displacement of the device is eliminated because it is secured to the barrel and magazine of a firearm. No removal of parts or disassembly of the firearm is required in order to mount the device. Lateral build up and complexity of components is reduced so storage of the firearm can be better realized.

### BRIEF DESCRIPTION OF THE DRAWINGS

The description refers to the accompanying drawings in which like designations refer to like bodies throughout the views.

FIG. 1 is an isometric illustration of the exemplary accessory mount for a weapon in accordance with the present invention.

FIG. 2 is an exploded isometric view of the exemplary accessory mount of FIG. 1.

FIG. 3 is a perspective view of an exemplary accessory mount made in accordance with the present invention secured to a firearm

FIG. 4 is an exploded perspective view of the opposing clamping sections and the compressible opening of the exemplary accessory mount of FIG. 1 and a flashlight during installation thereof on a firearm.

FIG. 5 is a cross section of the exemplary accessory clamp.

FIG. 6 is an exploded isometric view of an embodiment the exemplary accessory mount of FIG. 1

For purposes of clarity and brevity, like elements and components will bear the same designations and numbering throughout the Figures.

### DESCRIPTION OF THE PREFERRED EMBODIMENT

The present invention is an accessory mount for a firearm and, more particularly, an accessory mount that engages the barrel and magazine of the firearm.

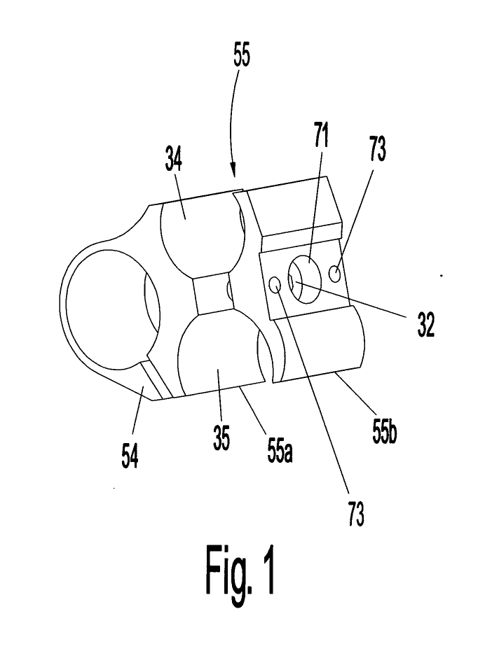

Referring now to the drawings, and more particularly to FIG. 1, there is shown a perspective view of an exemplary accessory mount 55 in accordance with the present invention. In the preferred embodiment the device may be formed from a metal such as aluminum, steel or other metal or metal alloy, various synthetic or composite materials such as a plastic, polymer or any combination thereof.

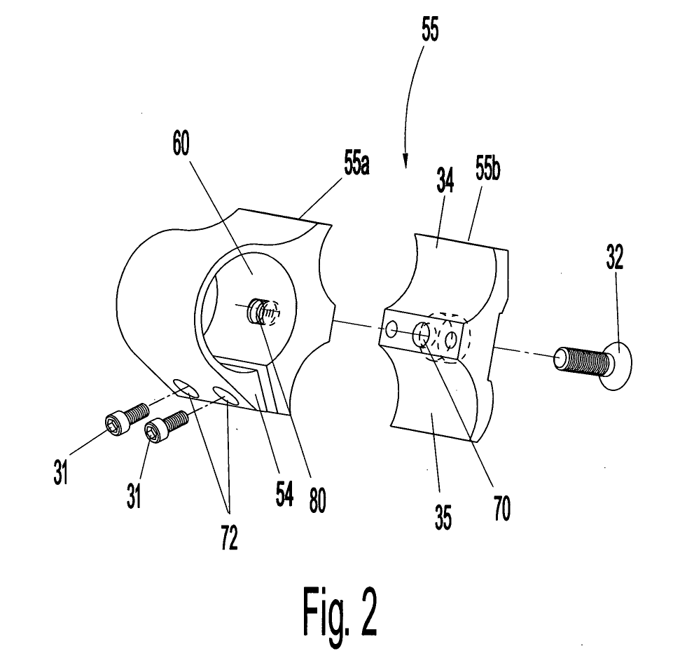

FIG. 2 shows an exploded view of the exemplary mount 55 which demonstrates the relationship between clamp section 55a and supporting clamp section 55b that forms the exemplary accessory mount 55 referenced in FIG. 1. Engaging surface 34, defined by supporting clamp section 55b is formed with arcuate surfaces that approximate the curvature of the firearm barrel. Engaging surface 35, of supporting clamp section 55b is formed with arcuate surfaces that approximate the curvature of the firearm magazine. Within the accessory receiving body 60 the threaded bore 80 defined by clamp section 55a is in registry with the hole 70 defined by section 55b, such that a fastener 32 or similar fastener can be passed through the hole 70 and is secured within threaded bore 80 or within a similar fastener. Referring to FIG. 1 engaging surface 34, defined by clamp section 55a is formed with arcuate surfaces that approximate the curvature of the firearm barrel. Engaging surface 35, of clamp section 55a is formed with arcuate surfaces that approximate the curvature of the firearm magazine. Exterior cavity 71 is defined by supporting clamp section 55b that has a corresponding shape to accept fastener 32 or similar fastener and is in registry of the hole 70 referenced in FIG. 2. Also in FIG. 1 there are demonstrated additional threaded bores 73 for the inclusion of an additional optional attachment configuration or configurations.

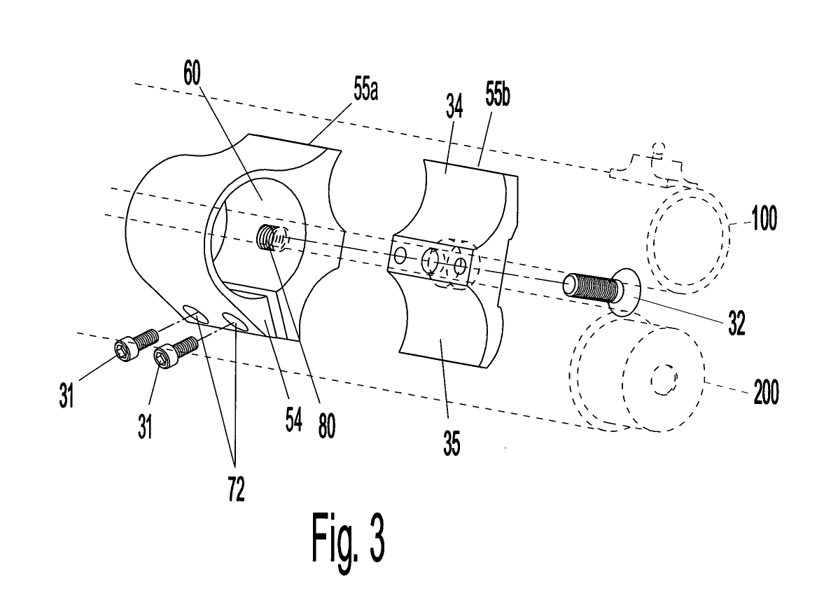

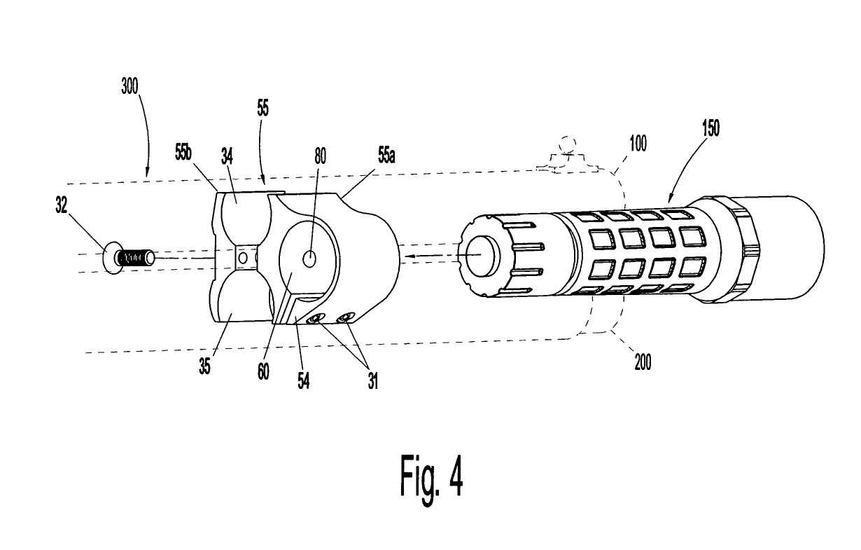

As best shown in FIG. 4 the clamp section 55a and supporting clamp section 55b are secured in an opposed fashion to attach the exemplary accessory mount 55 to the firearm 300 and releasably couple the barrel 100 and magazine 200 by use of a fastener 32 or similar fastener passing through hole 70 referenced in FIG. 2 and receiving threaded bore 80 or within a threaded fastener. FIG. 3 shows the exemplary accessory clamp 55 comprised of clamp section 55a and supporting clamp section 55b engaging the barrel 100 and the magazine 200 of the firearm 300.

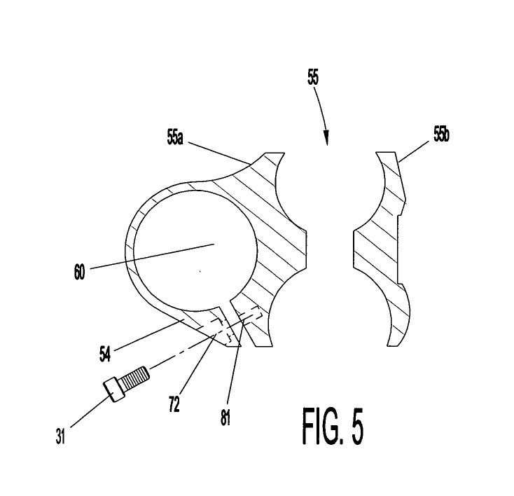

FIG.4 shows accessory receiving body 60 defined by clamp section 55a is adapted to receive a flashlight 150 or illumination device for a firearm 300 such as a flashlight 150. In this regard receiving body 60 is shaped in an arcuate form, or a form adapted to an accessory or approximate form of the accessory, where, clamping flange 54 completes the arcuate shape to secure the flashlight 150 or illumination device in the approximate form of the accessory or a form adapted to an accessory or approximate form of the accessory. After the accessory such as a flashlight 150 is inserted into the accessory receiving body 60 one or more fasteners 31 are used to secure the clamping flange 54 and apply holding pressure to the accessory or flashlight 150. FIG. 5 shows a cross section of the clamp section 55a at the hole 72 and threaded bore 81, with the accessory receiving body 60 and clamping flange 54. The threaded bore 81 defined by clamp section 55a is in registry with the hole 72 defined by section 55a, such that a fastener 31 or similar fastener can pass through the hole 72 and is secured within threaded bore 81 or within a similar fastener compressing flange 54 and securing the flashlight 150 or illuminuation device in position.

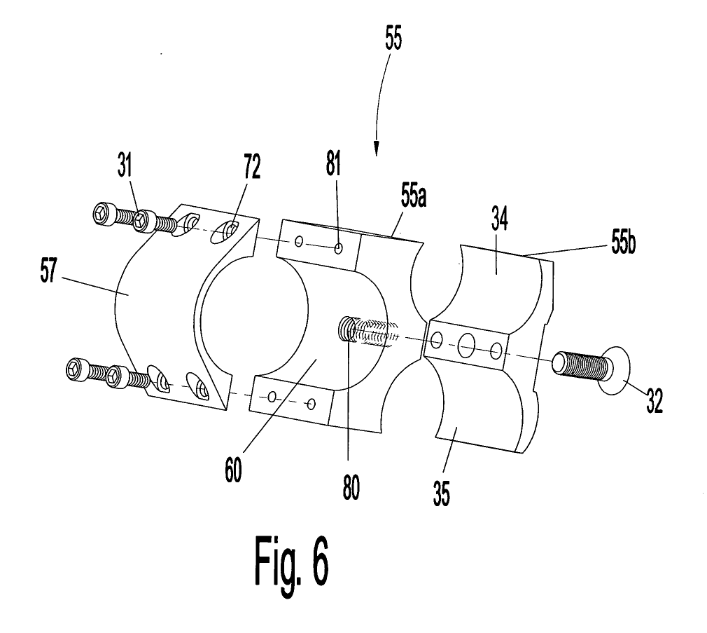

It is to be understood that while the accessory mount 55 is described in the context of attaching a flashlight to a firearm, one or more features of the present invention can be applied to other weapons and accessories known to those in the art. Thus, the present invention is not to be limited to the representative embodiment illustrated and described herein. One such embodiment as referenced in FIG. 6 is a perspective view of alternate embodiment of the invention. Specifically an accessory receiving body 60 is shaped in an arcuate form, or a form adapted to an accessory or approximate form of the accessory where, clamping flange 57 completes the arcuate shape, or a form adapted to an accessory or approximate form of the accessory. The threaded bore 81 defined by clamp section 55a is in registry with the hole 72 defined by the clamping flange 57, such that a fastener 31 or similar fastener can pass through the hole 72 and is secured within threaded bore 81 or within a similar fastener completing the arcuate shape, or a form adapted to an accessory or approximate form of the accessory. After an accessory is inserted into the accessory receiving body 60 one or more fasteners 31 pass through one or more holes 72 and are received in one or more bores 81 to removably couple the clamping flange 57 to the accessory receiving body 60 and apply holding pressure to the accessory.

Thus, in summary, it can be seen that what is provided in this invention is a barrel mounted accessory clamp having an integrated accessory holder. Having thus described the invention, what is desired to be protected by Letters Patent is presented in the subsequently appended claims.

What is claimed is:

1. A barrel mounted clamp having integrated accessory holder to attach a flashlight or illumination device to a shotgun barrel and Magazine tube assembly, comprising:
means for receiving a flashlight or illumination device;
means for stopping rotational displacement during stress;
means for attaching the device to a firearm;
means for securing a flashlight or illumination device; and
means for receiving one or more fasteners;

2. The barrel mounted clamp having integrated accessory holder in accordance with claim 1, wherein said means for attaching a light to a firearm comprises an exemplary accessory mount.

3. The barrel mounted clamp having integrated accessory holder in accordance with claim 1, wherein said means for attaching the device to a firearm comprises one or more fasteners.

4. The barrel mounted clamp having integrated accessory holder in accordance with claim 1, wherein said means for attaching the device to a firearm comprises one or more threaded bores or threaded fasteners.

5. The barrel mounted clamp having integrated accessory holder in accordance with claim 1, wherein said means for attaching the device to a firearm comprises a clamp section.

6. The barrel mounted clamp having integrated accessory holder in accordance with claim 1, wherein said means for attaching the device to a firearm comprises a supporting clamp section.

7. The barrel mounted clamp having integrated accessory holder in accordance with claim 1, wherein said means for attaching the device to a firearm comprises one or more barrel gripping surfaces.

8. The barrel mounted clamp having integrated accessory holder in accordance with claim 1, wherein said means for attaching the device to a firearm comprises one or more magazine gripping surfaces.

9. The barrel mounted clamp having integrated accessory holder in accordance with claim 1, wherein said means for receiving the fastener comprises one or more receiving bores.

10. The barrel mounted clamp having integrated accessory holder in accordance with claim 1, wherein said means for receiving the fastener comprises one or more bores.

11. The barrel mounted clamp having integrated accessory holder in accordance with claim 1, wherein said means for receiving the accessory comprises an accessory receiving body.

12. The barrel mounted clamp having integrated accessory holder in accordance with claim 1, wherein said means for securing the flashlight or illumination device within the accessory receiving body comprises a clamping flange.

13. The barrel mounted clamp having integrated accessory holder in accordance with claim 1, wherein said means for securing the flashlight or illumination device by the clamping flange comprises one or more receiving bores.

14. The barrel mounted clamp having integrated accessory holder in accordance with claim 1, wherein said means for securing the flashlight or illumination device within the receiving clamp body comprises one or more fasteners.

15. The barrel mounted clamp having integrated accessory holder in accordance with claim 1, wherein said means for securing the flashlight or illumination device within the receiving clamp section comprises one or more threaded bores or threaded fasteners.

16. A barrel mounted clamp having integrated accessory holder to attach a flashlight or illumination device to a shotgun barrel and magazine tube assembly, comprising:
an exemplary accessory mount, for attaching a flashlight or illumination device
a fastener, for <purpose>;
a threaded bore, for <purpose>;
a clamp section, for attaching to the firearm, and
a supporting clamp section, for attaching to the firearm
a clamping flange, for securing the flashlight or illumination device;
a barrel gripping surface, for attaching the device to a firearm;
a magazine gripping surface, for attaching the device to a firearm;
one or more receiving bores, for receiving one or more fasteners;
one or more threaded bores, for receiving one or more fasteners;
One or more fasteners, for securing the clamping flange to the receiving clamp body; and
a receiving clamp body, for receiving the flashlight or illumination device.
